(19) United States
(12) Patent Application Publication
(10) Pub. No.: US 2010/0303426 A1
(43) Pub. Date: Dec. 2, 2010

(54) DOWNHOLE OPTICAL FIBER SPICE HOUSING

(75) Inventor: Brad W. Davis, Clear Lake, IA (US)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/474,363

(22) Filed: May 29, 2009

(51) Int. Cl. G02B 6/255; G02B 6/00

(52) U.S. Cl. 385/95; 385/134; 385/135

(57) ABSTRACT

An apparatus for protecting a splice between optical fibers disposed in a borehole penetrating the earth, the apparatus including: a housing configured to be disposed in the borehole and having a first port and a second port, each port being configured to seal the housing to an associated fiber optic cable containing an optical fiber to be spliced; wherein the housing includes a sealed interior volume sufficient to contain a splice of the optical fibers for protection and to enable a functional bend of at least ninety degrees for at least one spliced optical fiber.

### BACKGROUND OF THE INVENTION

1. Field of the Invention

The present invention relates to protecting an optical fiber splice and, in particular, to protecting the splice in a borehole environment.

2. Description of the Related Art

In the hydrocarbon recovery arts, a borehole is drilled into the earth for production of the hydrocarbons. Many types of components may be disposed in the borehole for the production of the hydrocarbons. Instrumentation for monitoring various conditions is one type of component that may be disposed in the borehole. In addition, a communication medium is used to communicate instrumentation measurements to the surface of the earth for processing and recording.

The borehole can present a very harsh environment to the downhole components. In many cases, the borehole is filled with a fluid at a high pressure and temperature. In addition, the fluid can have abrasive and chemical properties that can damage the downhole components. Failure of the downhole components due to the harsh borehole environment can be costly both in terms of repair and in lost production. Thus, the instrumentation and the communication medium need to be well protected.

One type of communication medium that lends itself to use in the borehole environment is a fiber optic cable. The fiber optic cable generally has an armored sheath surrounding one or more optical fibers. One optical fiber can transmit and receive signals from an instrument downhole. When more than one instrument is deployed downhole, the fiber optic cable generally has an optical fiber assigned for each instrument. For example, if four instruments are deployed downhole, then the fiber optic cable will have at least four separate optical fibers.

A splice is required downhole for each connection of an optical fiber to the assigned instrument. Thus, as the fiber optic cable progresses downhole, several splices may be required to “break out” each assigned optical fiber to the respective instrument.

Historically, an “upside-down Y-splice assembly” with one leg oriented uphole and two legs oriented downhole is used to break out an optical fiber to an instrument located nearby while allowing the rest of the optical fibers in the cable to continue further downhole.

Unfortunately, there are a number of issues with using the upside-down Y-splice assembly. If the instrument to be connected is uphole of the splice, then the fiber optic cable coming out of one of the downhole legs for the instrument has to be bent 180 degrees. Because the cable is armored, the minimum bend radius may be too large or cumbersome to make the bend. Another issue is that there is a limited amount of room within the assembly such that if a splice between two bare optical fibers fails, there is limited room for excess length of unarmored optical fibers to attempt one or two more tries at splicing the optical fibers. After one or two unsuccessful tries, more of the armored jacket has to be removed and the splicing process started again.

Therefore, what are needed are improved techniques for splicing fiber optic cables downhole. Preferably, the techniques provide for reversing direction of one leg exiting the splice and allowing enough excess unarmored optical fibers to attempt many tries at splicing before the armored jacket has to be removed and the splicing process started afresh.

### BRIEF SUMMARY OF THE INVENTION

Disclosed is an apparatus for protecting a splice between optical fibers disposed in a borehole penetrating the earth, the apparatus including: a housing configured to be disposed in the borehole and having a first port and a second port, each port being configured to seal the housing to an associated fiber optic cable containing an optical fiber to be spliced; wherein the housing comprises a sealed interior volume sufficient to contain a splice of the optical fibers for protection and to enable a functional bend of at least ninety degrees for at least one spliced optical fiber.

Also disclosed is a system for communicating a light signal between a remote location and at least two instruments disposed in a borehole penetrating the earth, the system including: a housing configured to be disposed in the borehole and having a first port oriented in a downhole direction and a second port and a third port oriented in an uphole direction, each port being configured to seal the housing to a fiber optic cable, wherein the housing includes a sealed interior volume sufficient to contain a splice between optical fibers for protection and to enable a functional bend of at least 180 degrees for at least one spliced optical fiber; a first fiber optic cable sealed to the first port and in communication with a first instrument; a second fiber optic cable sealed to the second port and in communication with a second instrument; a third fiber optic cable sealed to the third port and comprising a first optical fiber for communicating the light signal between the remote location and the first instrument and a second optical fiber for communicating the light signal between the remote location and the second instrument; a first splice disposed within the housing and configured to communicate the light signal from the first optical fiber to the first instrument using the first fiber optic cable; and a second splice disposed within the housing and configured to communicate the light signal from the second optical fiber to the second instrument using the second fiber optic cable.

Further disclosed is a method for protecting a splice between optical fibers disposed in a borehole penetrating the earth, the method including: selecting a housing configured to be disposed in the borehole and having a first port and a second port, each port being configured to seal the housing to an associated fiber optic cable containing an optical fiber to be spliced wherein the housing includes a sealed interior volume sufficient to contain a splice of the optical fibers for protection and to enable a functional bend of at least ninety degrees for at least one spliced optical fiber; splicing two optical fibers to produce a splice, wherein each optical fiber is contained in at least one fiber optic cable sealed to the housing; disposing the splice in the housing; and disposing the housing in the borehole.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a fiber optic splice housing disposed in a borehole penetrating the earth;

FIGS. 2A, 2B, 2C and 2D, collectively referred to as FIG. 2 depict aspects of a fiber optic splice housing;

FIG. 3 depicts aspects of fiber optic cable connections to the fiber optic housing; and

FIG. 4 presents one method of splicing optical fibers for use downhole.

### DETAILED DESCRIPTION OF THE INVENTION

Disclosed are exemplary embodiments of techniques for protecting splices of optical fibers downhole. The techniques, which include method and apparatus, allow splices between optical fibers in fiber optic cables oriented in uphole and/or downhole directions without requiring bending an armored jacket surrounding the cable. In addition, the techniques provide for storing an excess amount of optical fibers removed from the armored jacket. The excess amount of the optical fibers allows many attempts at splicing the optical fibers before fiber optic cables containing the fibers have to be disassembled to have more of the armored jacket removed.

For convenience, certain definitions are presented. The term “downhole” relates to at least one of being located in a borehole and a direction leading to deeper or further in the borehole. A downhole direction relates to any direction having a directional component pointing downhole. The term “uphole” relates to a direction from within a borehole leading to the entrance of the borehole. An uphole direction relates to any direction having a directional component pointing uphole.

The term “fiber optic cable” relates to a cable containing one or more optical fibers that are configured for transmitting a light such as a light signal. The fiber optic cable in general is protected from a borehole environment by an outer covering, which can include an armored jacket. A fiber optic cable leading from or integral with an instrument may contain only one optical fiber for communicating a light signal. The term “stripped optical fiber” relates to an optical fiber with no outer covering or armored jacket or an optical fiber having a jacket enclosing only that optical fiber, i.e., an optical fiber stripped from an armored jacket and any coverings of the armored jacket.

The term “instrument” relates to any sensor or gauge used for measuring a property of a borehole environment, a formation, or a structure or apparatus disposed in a borehole. Non-limiting examples of measured properties include pressure, temperature, displacement, acceleration, gravity, force, stress, strain, speed, flow and chemical.

The techniques disclosed herein use an optical fiber splice housing for protecting a splice between two optical fibers from a harsh environment downhole. In one embodiment, the splice housing includes two ports oriented in an uphole direction and two ports oriented in a downhole direction. Each port is configured to seal a fiber optic cable entering the housing. In general, sealing is accomplished by using threaded connections having at least one ferrule to seal the cable to the ferrule and to seal the ferrule to the splice housing.

To protect the splices of optical fibers downhole, the optical fiber splice housing is watertight, vacuum resistant, and pressure resistant to at least 10,000 psi.

The splice housing has sufficient volume to contain a splice between two optical fibers. The splice can be a fusion splice, a mechanical splice, or any type of splice known in the art. The splice housing also has sufficient volume to allow an optical fiber stripped from the outer covering of the fiber optic cable to make a bend from at least ninety (90) degrees to over 180 degrees without violating the minimum required bend radius of the optical fiber to remain functional. To this end, the splice housing includes one or more cylindrical posts each having a radius that meets or exceeds at least the minimum bend radius. In addition, the splice housing has sufficient volume to store in a controlled manner excess lengths of optical fibers that were stripped from the outer covering of the fiber optic cable. In general, the storage of the excess lengths of the stripped optical fibers is controlled by wrapping the excess lengths of the stripped optical fibers around the one or more cylindrical posts. Thus, the posts provide for routing of the stripped optical fibers at either end of the splice to an appropriate port for connection to another fiber optic cable. In one embodiment, the excess length of a stripped optical fiber to be stored can be at least two feet.

The interior of the splice housing is accessed through an opening sealed by a splice housing lid. In one embodiment, the splice housing lid is secured and sealed to the splice housing by a plurality of cap screws and a double o-ring seal. The splice housing with the splice housing lid in place provides an environment protected from the borehole environment for splices and excess stripped fiber optic cable.

The dimensions of the splice housing are small enough to allow attaching the splice housing to the side of a casing that will be disposed in a borehole without subjecting the housing to damage from the borehole wall. Further protection may be provided by shielding the housing with a protector configured to clamp to the casing above and below the housing. The protector covers the housing with a shield disposed between the clamps.

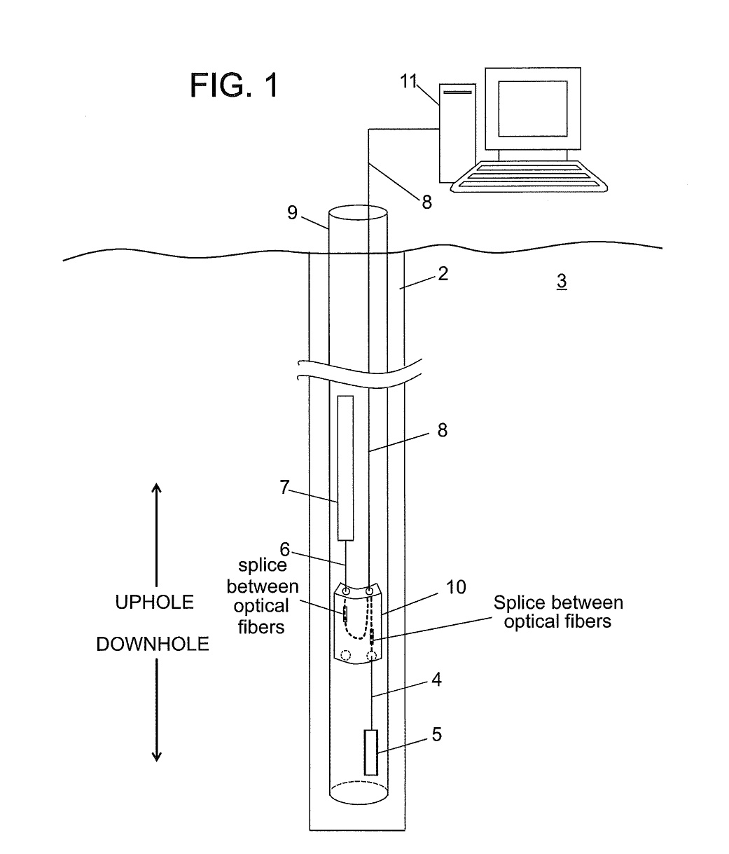

Reference may now be had to FIG. 1. FIG. 1 illustrates an exemplary embodiment of a splice housing 10 attached to a casing 9 disposed in a borehole 2 penetrating the earth 3. Connected to the splice housing 10 is a first fiber optic cable 4 connected to a first instrument 5, a second fiber optic cable 6 connected to a second instrument 7, and a third fiber optic cable 8. The first fiber optic cable 4 extends downhole from the housing 10. The second fiber optic 6 cable extends uphole from the housing 10. The third fiber optic cable 8 extends uphole from the housing 10 and connects to a fiber optic processing unit 11 used to communicate optically with the first instrument 5 and the second instrument 7.

Each of the first instrument 5 and the second instrument 7 are configured to perform a measurement of a property in the borehole 2. The property can be an environmental condition such as temperature or pressure. The property can also be related to a condition experienced by downhole production equipment such as a stress experienced by the casing 9. In another embodiment, other splice housings 10 can be used to splice other instruments or communications/processing apparatus to a fiber optic cable extending further downhole. Thus, several of the housings 10 can be coupled in series to the casing 9 to break out optical fibers to nearby instruments as needed.

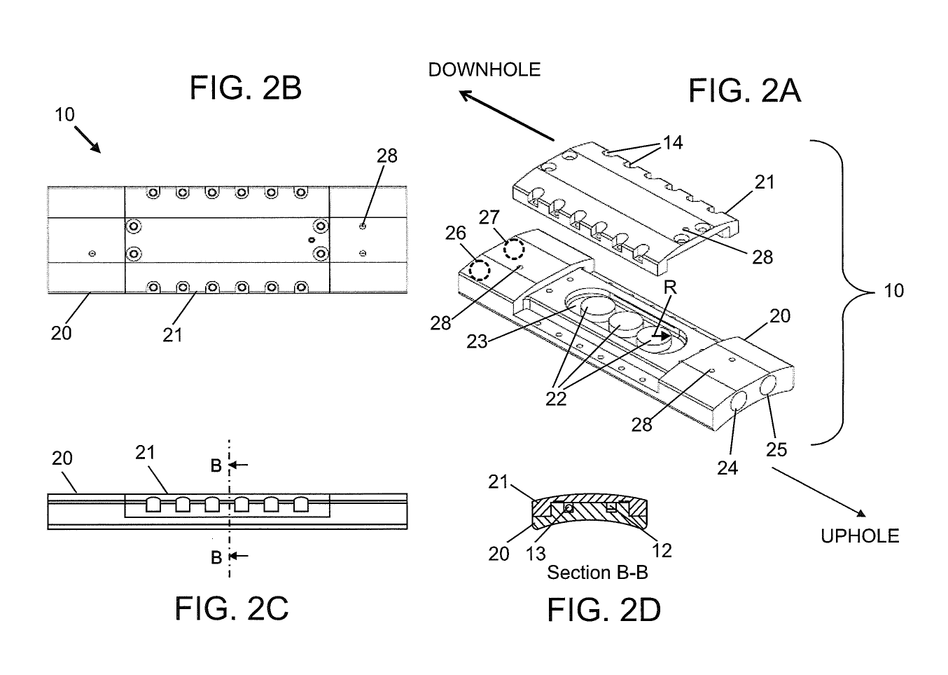

Reference may now be had to FIG. 2. FIG. 2 depicts aspects of the splice housing 10. Referring to FIG. 2A, the splice housing 10 includes a housing body 20 and a housing lid 21. The housing lid 21 is configured to mate to the housing body 20 to seal an interior volume 23 from the external environment. The interior volume 23 is large enough to contain at least two splices between stripped optical fibers and enable a functional bend of at least ninety (90) degrees and, in general, up to 180 degrees (or 360 degrees for storing excess lengths of stripped optical fibers). In addition, the interior volume 23 is large enough to contain excess length of the stripped optical fibers to enable many tries at splicing should a splice fail without resorting to removing any of the fiber optic cables 4, 6 or 8 from the splice housing 10 to remove more of the armored jacket. The housing body 20 includes ports 24, 25, 26 and 27 so that fiber optic cables (such as the first fiber optic cable 4, the second fiber optic cable 6, and the third fiber optic cable 8) can be connected and sealed to the interior 23. Ports 24 and 25 are oriented in an uphole direction and ports 26 and 27 oriented in a downhole direction. The ports 24 and 25 can also be described as being oriented about 180 degrees from the ports 26 and 27.

Still referring to FIG. 2A, the housing lid 21 includes a plurality of recesses 14 to protect the cap screws securing the lid 21 to the housing body 20.

Still referring to FIG. 2A, the splice housing 10 includes a plurality of test ports 28. Each test port 28 can be used to pressure test the housing 10 for leakage. The pressure test can include increasing or decreasing the pressure internal to the housing 10 and monitoring the pressure for a change that would indicate leakage. Each test port 28 is configured to be sealed with a plug after completion of testing.

Still referring to FIG. 2A, disposed in the interior 23 are three fiber management posts 22 each having a radius, R. The radius R is at least the minimum bend radius that the stripped optical fibers can withstand and remain functional. The fiber management posts 22 can be used to wrap the excess length of any stripped optical fibers and can be used to change direction of spliced optical fibers to lead to one of the ports. As one example, each post 22 can be used to coil the excess length of different stripped optical fibers.

FIG. 2B illustrates a top view of the splice housing 10 with the housing lid 21 installed on the housing body 20. FIG. 2C illustrates a side view of the splice housing 10 with the housing lid 21 installed on the housing body 20. FIG. 2D illustrates a cross-sectional view of the splice housing 10 with the housing lid 21 installed on the housing body 20. Referring to FIG. 2D, the housing body includes a groove 12 configured to contain a first O-ring 13 for sealing the lid 21 to the body 20.

As shown in FIGS. 2A and 2D, the lower portion of the housing body 20 is curved to conform to the curvature of the casing 9. The curvature of the housing body 20 allows for a close fit to the casing 9 when the splice housing 10 is clamped to the casing 9. The close fit helps to prevent interference with the wall of the borehole 2.

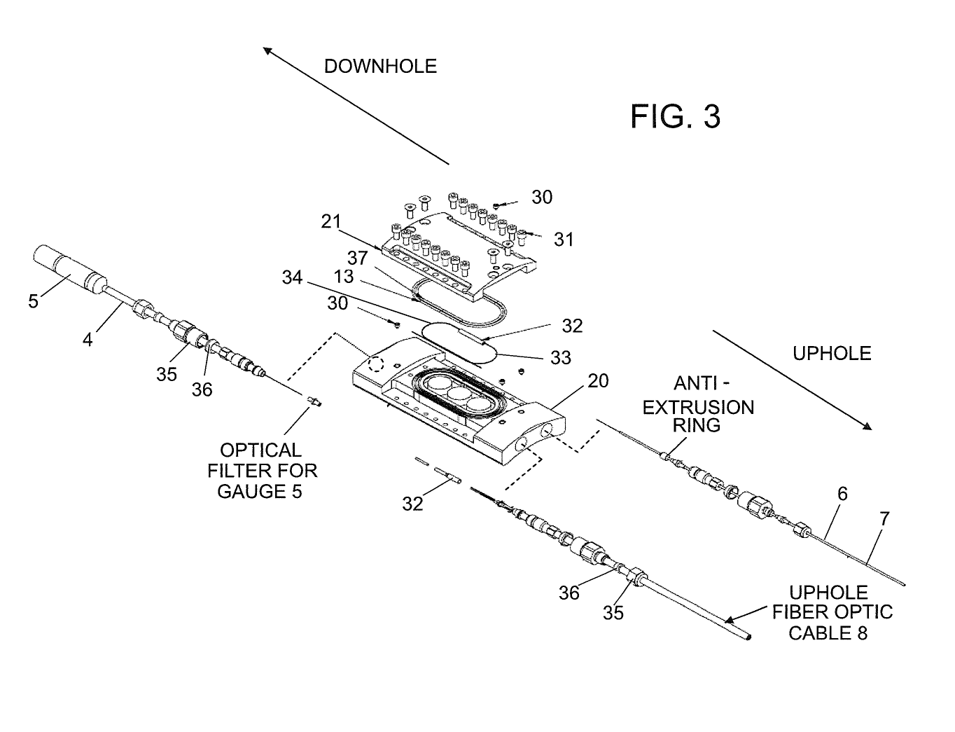

FIG. 3 illustrates an exploded view of the splice housing 10 with the fiber optic cables 4, 6, and 8 and with the first instrument 5 and the second instrument 7. In the embodiment of FIG. 3, the second fiber optic cable 6 is also the second instrument 7. The second instrument 7 in this embodiment is a distributed strain sensor configured to measure strain at various points along the fiber optic cable 6. The second fiber optic cable 6 includes a plurality of etched fiber Bragg gratings used to measure the strain of a structure such as the casing 9 to which the cable 6 is attached. Thus, as the spacings between refractive index changes of each grating changes in response to a strain, a measurement of the spacing can be related to the strain at the various points. A measurement in a change of the frequency of light reflected by a grating is generally used as a measure of the change in spacing between the refractive index changes of the grating.

Referring to FIG. 3, FIG. 3 depicts a plurality of test port plugs 30 used to seal the test ports 28. Also depicted in FIG. 3 is a plurality of cap screws 31 used to secure the housing lid 21 to the housing body 20. Also depicted in FIG. 3 is an inner O-ring 37 to provide added sealing protection between the housing body 20 and the housing lid 21. Also depicted in FIG. 3 is a splice protector sleeve 32 used to cover and protect a splice between optical fibers 33 and 34 contained within the splice housing 10. Also depicted in FIG. 3 are threaded fittings 35 and ferrules 36 used to seal the fiber optic cables 4, 6 and 8 to the housing body 20.

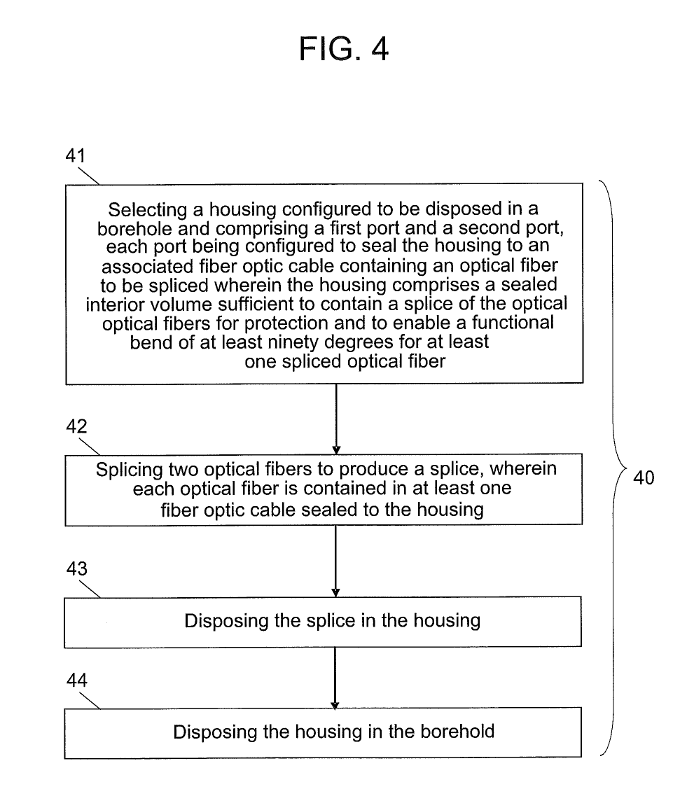

FIG. 4 presents one example of a method 40 for protecting a splice between optical fibers disposed in the borehole 2 penetrating the earth 3. The method 40 calls for (step 41) selecting the splice housing 10. Further, the method 40 calls for (step 42) splicing two optical fibers to produce the splice, wherein each optical fiber is contained in at least one fiber optic cable sealed to the housing 10. Further, the method 40 calls for (step 43) disposing the splice in the housing 10. Further, the method 40 calls for (step 44) disposing the housing 10 in the borehole 2.

Various other components may be included and called upon for providing aspects of the teachings herein. For example, a bracket for mounting the housing 10 to the casing 9, a power supply (e.g., at least one of a generator, a remote supply and a battery), vacuum supply, pressure supply, cooling component, heating component, sensor, instrument component, gauge, transmitter, receiver, transceiver, controller, optical unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first,” “second,” “third” and “fourth” are used to distinguish elements and are not used to denote a particular order.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for protecting a splice between optical fibers disposed in a borehole penetrating the earth, the apparatus comprising:
a housing configured to be disposed in the borehole and comprising a first port and a second port, each port being configured to seal the housing to an associated fiber optic cable containing an optical fiber to be spliced;
wherein the housing comprises a sealed interior volume sufficient to contain a splice of the optical fibers for protection and to enable a functional bend of at least ninety degrees for at least one spliced optical fiber.

2. The apparatus of claim 1, wherein the functional bend is at least 135 degrees.

3. The apparatus of claim 2, wherein the functional bend is at least 180 degrees.

4. The apparatus of claim 3, wherein the functional bend is at least 360 degrees.

5. The apparatus of claim 1, wherein the first port and the second port are oriented in the uphole direction and the housing further comprises a third port oriented in a downhole direction, the third port being configured to seal the housing to an associated fiber optic cable containing an optical fiber to be spliced.

6. The apparatus of claim 5, wherein the housing further comprises a fourth port oriented in the downhole direction, the fourth port being configured to seal the housing to an associated fiber optic cable containing an optical fiber to be spliced.

7. The apparatus of claim 1, wherein the interior volume is sufficient to store an excess length of each spliced optical fiber.

8. The apparatus of claim 7, wherein the excess length comprises at least two feet.

9. The apparatus of claim 7, wherein the housing further comprises a post configured to have the excess length of each spliced optical fiber wrapped thereon.

10. The apparatus of claim 1, wherein the housing further comprises a test port configured to pressure test the integrity of seals sealing the interior volume.

11. The apparatus of claim 10, further comprising a plug configured to seal the test port.

12. The apparatus of claim 1, wherein the housing is configured to be secured to a casing disposed in the borehole.

13. The apparatus of claim 8, wherein the housing comprises a curved shape configured to conform to the casing.

14. The apparatus of claim 1, wherein the housing comprises a housing body and a housing lid configured to seal to the housing body to provide the sealed interior volume.

15. The apparatus of claim 14, further comprising a plurality of screws configured to secure the housing lid to the housing body.

16. The apparatus of claim 14, further comprising an O-ring configured to seal the housing lid to the housing body.

17. The apparatus of claim 1, wherein each port is configured to seal the housing to a fiber optic cable using a ferrule surrounding the fiber optic cable

18. A system for communicating a light signal between a remote location and at least two instruments disposed in a borehole penetrating the earth, the system comprising:
a housing configured to be disposed in the borehole and comprising a first port oriented in a downhole direction and a second port and a third port oriented in an uphole direction, each port being configured to seal the housing to a fiber optic cable, wherein the housing comprises a sealed interior volume sufficient to contain a splice between optical fibers for protection and to enable a functional bend of at least 180 degrees for at least one spliced optical fiber;
a first fiber optic cable sealed to the first port and in communication with a first instrument;
a second fiber optic cable sealed to the second port and in communication with a second instrument;
a third fiber optic cable sealed to the third port and comprising a first optical fiber for communicating the light signal between the remote location and the first instrument and a second optical fiber for communicating the light signal between the remote location and the second instrument;
a first splice disposed within the housing and configured to communicate the light signal from the first optical fiber to the first instrument using the first fiber optic cable; and
a second splice disposed within the housing and configured to communicate the light signal from the second optical fiber to the second instrument using the second fiber optic cable.

19. The system as in claim 18, wherein one of the optical fibers connected to the second splice is bent at least 180-degrees to enable communication between the third fiber optic cable and the second fiber optic cable.

20. The system as in claim 18, wherein at least one of the first instrument and the second instrument is configured to measure at least one property from a group consisting of pressure, temperature, displacement, acceleration, gravity, force, stress, strain, speed, flow and chemical.

21. A method for protecting a splice between optical fibers disposed in a borehole penetrating the earth, the method comprising:
selecting a housing configured to be disposed in the borehole and comprising a first port and a second port, each port being configured to seal the housing to an associated fiber optic cable containing an optical fiber to be spliced wherein the housing comprises a sealed interior volume sufficient to contain a splice of the optical fibers for protection and to enable a functional bend of at least ninety degrees for at least one spliced optical fiber;
splicing two optical fibers to produce a splice, wherein each optical fiber is contained in at least one fiber optic cable sealed to the housing;
disposing the splice in the housing; and
disposing the housing in the borehole.

22. The method of claim 21 further comprising bending one spliced optical fiber at least ninety degrees to connect a fiber optic cable sealed at the first port with a fiber optic cable sealed at the second port.
